(19) United States
(12) Patent Application Publication
(10) Pub. No.: US 2015/0340665 A1
(43) Pub. Date: Nov. 26, 2015

(54) RECHARGEABLE BATTERY

(71) Applicant: SAMSUNG SDI CO., LTD., Yongin-si (KR)

(72) Inventors: In KIM, Yongin-si (KR); Sang-Won BYUN, Yongin-si (KR); Won-Jun LEE, Yongin-si (KR); Hong-Hyeon LEE, Yongin-si (KR); Jae-Kyung KIM, Yongin-si (KR); Soo-Seok CHOI, Yongin-si (KR); Hyun-Chul KIM, Yongin-si (KR); Hyun SOH, Yongin-si (KR)

(21) Appl. No.: 14/644,380

(22) Filed: Mar. 11, 2015

(30) Foreign Application Priority Data
May 26, 2014 (KR) 10-2014-0063292

(51) Int. Cl. H01M 2/04; H01M 2/34; H01M 10/42; H01M 2/30

(52) U.S. Cl. CPC H01M 2/0473; H01M 2/30; H01M 2/34; H01M 10/4235

(57) ABSTRACT

A rechargeable battery includes an electrode assembly in a case, a cap plate sealing an opening of the case, a terminal portion electrically coupled to the electrode assembly, the terminal portion being on the cap plate, and a connecting member extending from the terminal portion and being spaced apart from the cap plate, the connecting member electrically coupling the terminal portion and the cap plate.

### CROSS-REFERENCE TO RELATED APPLICATION

Korean Patent Application No. 10-2014-0063292, filed on May 26, 2014, in the Korean Intellectual Property Office, and entitled: “Rechargeable Battery,” is incorporated by reference herein in its entirety.

### BACKGROUND

1. Field

The present disclosure relates to a rechargeable battery, and more particularly, to a rechargeable battery including a structure that can prevent an electrode assembly from being damaged.

2. Description of the Related Art

A rechargeable battery differs from a primary battery in that it can be repeatedly charged and discharged, while the latter is incapable of being recharged. A low-capacity rechargeable battery may be used in small portable electronic devices, e.g., mobile phones, notebook computers, and camcorders, while a high-capacity rechargeable battery may be used as a power source, e.g., for driving a motor of hybrid vehicles or high-capacity power storage devices.

Recently, a high power rechargeable battery using a non-aqueous electrolyte and having high energy density has been developed. The high power rechargeable battery is configured such that a plurality of rechargeable batteries are connected in series for high power so as to be used as a power source for driving a motor of a device requiring a large amount of electric power, e.g., electric vehicles and the like. Such a high power rechargeable battery may have a case in the shape of, e.g., a cylinder, a prism, etc.

### SUMMARY

An exemplary embodiment provides a rechargeable battery, including an electrode assembly in a case, a cap plate sealing an opening of the case, a terminal portion electrically coupled to the electrode assembly, the terminal portion being on the cap plate, and a connecting member extending from the terminal portion and being spaced apart from the cap plate, the connecting member electrically coupling the terminal portion and the cap plate.

The connecting member may include a first coupling portion coupled to the terminal portion, a bent portion bent toward the cap plate from the first coupling portion, and a second coupling portion elongated from the bent portion to be coupled to the cap plate.

The connecting member may further include a protruding portion that protrudes toward the cap plate from one end of the second coupling portion to be coupled to the cap plate.

The second coupling portion may be spaced apart from the cap plate.

The first coupling portion may include a first coupling portion body that is formed with a plurality of protrusions.

The terminal portion may include a terminal member electrically coupled to the electrode assembly and installed to penetrate through the cap plate, and a terminal plate coupled to the terminal member to be electrically coupled to the cap plate by way of the connecting member.

The first coupling portion may be positioned between the cap plate and the terminal plate to be coupled to the terminal plate, the second coupling portion may be positioned between the cap plate and the terminal plate to be coupled to the cap plate, and insulating layers may be formed on surfaces of the first coupling portion and the second coupling portion facing each other.

The bent portion may include a plurality of bent portions.

Each of cross-sections of the bent portions may have a sinuous filament shape.

The connecting member may be installed inside of the case to face the electrode assembly.

The connecting member may have a rotated U-shape, a first end of the U-shape being connected to the terminal portion, and a second end of the U-shape being connected to the cap plate.

The rotated U-shape may extend continuously from the terminal portion along the cap plate to completely overlap an injection opening in the cap plate.

Only the second end of the rotated U-shape may contacts the cap plate.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a rechargeable battery according to a first exemplary embodiment through which conductive materials penetrate.

FIG. 2 illustrates a cross-sectional view of FIG. 1 taken along the line II-II.

FIG. 3 illustrates a perspective, enlarged view of a connecting member of the rechargeable battery of FIG. 1.

FIG. 4 illustrates a cross-sectional view of FIG. 1 taken along the line

FIG. 5 illustrates a graph comparing voltage and temperature variations of first electrodes of exemplary and comparative rechargeable battery through which a conductive foreign material penetrates.

FIG. 6 illustrates a graph of temperature variation of negative and positive electrodes according to time after a fuse operates in a conventional rechargeable battery, and temperature variation of negative and positive electrodes according to time after a fuse portion of the rechargeable battery of FIG. 1 is melted.

FIG. 7 illustrates a perspective view of a connecting member according to a second exemplary embodiment.

FIG. 8 illustrates a cross-sectional view of a rechargeable battery according to a third exemplary embodiment.

FIG. 9 illustrates a cross-sectional view of a rechargeable battery according to a fourth exemplary embodiment.

FIG. 10 illustrates a perspective view of a connecting member of the rechargeable battery of FIG. 9.

FIG. 11 illustrates a cross-sectional view of FIG. 10 taken along the line XI-XI.

### DETAILED DESCRIPTION

Example embodiments will now be described more fully hereinafter with reference to the accompanying drawings; however, they may be embodied in different forms and should not be construed as limited to those set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present. Like reference numerals refer to like elements throughout.

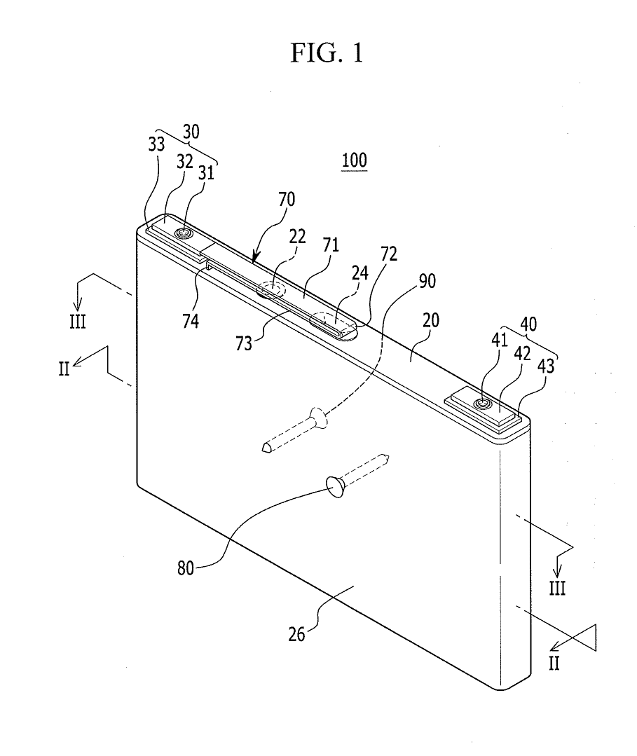

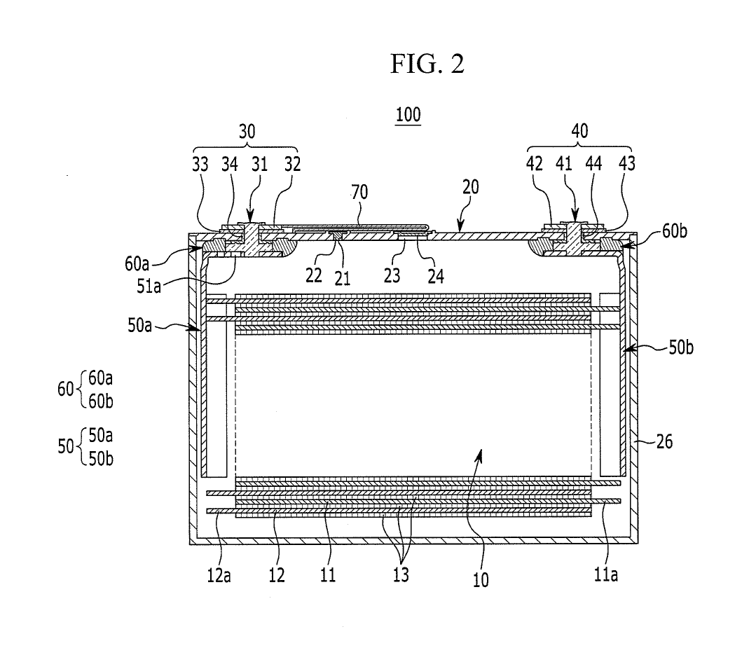

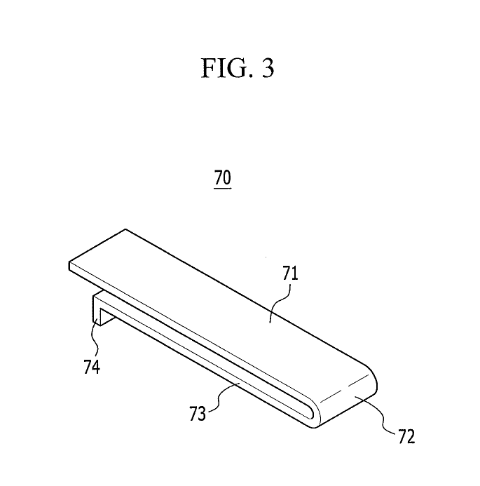

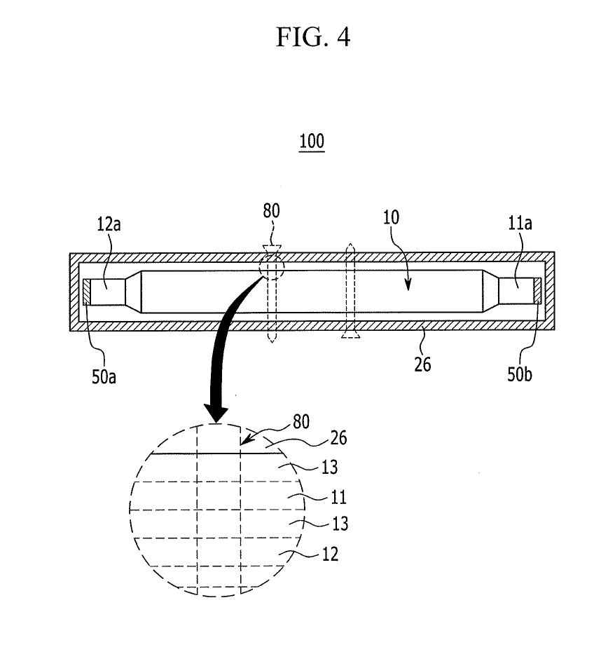

FIG. 1 is a perspective view of a rechargeable battery according to a first exemplary embodiment through which conductive materials penetrate, FIG. 2 is a cross-sectional view of FIG. 1 taken along the line II-II, FIG. 3 is a perspective view of a connecting member of the rechargeable battery of FIG. 1, and FIG. 4 is a cross-sectional view of FIG. 1 taken along the line III-III.

Referring to FIGS. 1 and 2, a rechargeable battery 100 according to a present exemplary embodiment may include an electrode assembly 10, a cap plate 20, a case 26, terminal portions 30 and 40 including first and second terminal portions 30 and 40, a current collecting member 50 including first and second current collecting members 50a and 50b that are formed with a fuse portion 51a, a lower insulating member 60 including first and second lower insulating members 60a and 60b, and a connecting member 70.

The electrode assembly 10 according to the present exemplary embodiment may be formed, e.g., in a jelly-roll form by spirally winding a first electrode 11, a second electrode 12, and a separator 13. For example, the first electrode 11 may be a negative electrode and the second electrode 12 may be a positive electrode.

In addition, the first and second electrodes 11 and 12 may respectively include a current collector formed of a thin metal foil and an active material coated on a surface of each current collector. Specifically, the first and second electrodes 11 and 12 may include coated regions where an active material is coated on the current collector, and first and second electrode uncoated regions 11a and 12a, which are disposed at opposite sides of the coated regions in the jelly-roll form and where the active material is not coated on the current collector. However, the electrode assembly 10 according to the present exemplary embodiment is not limited to being formed in the jelly-roll form, and the first and second electrodes 11 and 12 formed by a plurality of sheets may interpose a separator 13 therebetween to have a layered structure.

The case 26 according to the present exemplary embodiment is formed with an opening, and the electrode assembly 10 may be inserted through the opening to be accommodated in the case 26. The cap plate 20 according to the present exemplary embodiment is combined with, e.g., inserted into, the opening of the case 26 to seal the case 26. In addition, the cap plate 20 may include an electrolyte injection opening 21, a sealing cap 22 for sealing the electrolyte injection opening 21, a vent plate 24 to be ruptured when internal pressure of the case 26 exceeds a predetermined pressure, and a vent hole 23 at which the vent plate 24 is installed.

The terminal portions 30 and 40 according to the present exemplary embodiment include terminal members 31 and 41, terminal plates 32 and 42, terminal insulating members 33 and 43, and gaskets 34 and 44, respectively.

Specifically, the first terminal portion 30 of the terminal portions 30 and 40 may include a first terminal member 31, a first terminal plate 32, a first terminal insulating member 33, and a first gasket 34. In this case, while being electrically coupled to the second electrode 12 of the electrode assembly 10 through the first current collecting member 50a, the first terminal member 31 may be installed to penetrate through the cap plate 20. The first terminal plate 32 may be combined, e.g., coupled, to the first terminal member 31 to be electrically coupled to the second electrode 12 of the electrode assembly 10 through the first terminal member 31. The first terminal insulating member 33 may be installed between the first terminal plate 32 and the cap plate 20 to insulate therebetween, and the first gasket 34 may be installed between the first terminal member 31 and the cap plate 20 to insulate therebetween.

Similarly, the second terminal portion 40 of the terminal portions 30 and 40 may include a second terminal member 41, a second terminal plate 42, a second terminal insulating member 43, and a second gasket 44. In this case, a detailed description of the configuration forming the second terminal portion 40 will be omitted, since the second terminal portion 40 and the first terminal portion 30 have the same configuration. That is, the second terminal member 41 of the second terminal portion 40 according to the present exemplary embodiment may be electrically coupled to the first electrode 11 of the electrode assembly 10 through the second current collecting member 50b, and the second terminal plate 42 may be coupled to the second terminal member 41 such that it is electrically coupled to the first electrode 11 of the electrode assembly 10 through the second terminal member 41.

The connecting member 70 according to the present exemplary embodiment may at least partially protrude from the first terminal portion 30, and is spaced apart from the cap plate 20 so as to electrically couple the first terminal portion 30 and the cap plate 20. The connecting member 70 is formed of a material including, e.g., aluminum or an alloy including aluminum, and may include a first coupling portion 71, a bent portion 72, and a second coupling portion 73.

Referring to FIGS. 1 and 3, the first coupling portion 71 may be formed such that its first end is combined to the first terminal plate 32 of the first terminal portion 30, and is elongated in a distancing direction from the first terminal plate 32 substantially in parallel with the cap plate 20. The bent portion 72 is bent to extend toward the cap plate 20 from a second end of the first coupling portion 71, which is opposite to the first end of the first coupling portion 71. The second coupling portion 73 is combined to the cap plate 20 such that it is at least partially spaced apart therefrom, and extends from the bent portion 72 in an approaching direction toward the first terminal plate 32 substantially parallel to the first coupling portion 71. For example, as illustrated in FIG. 3, the first and second coupling portions 71 and 73 may overlap and be parallel to each other, and may be connected to each other via the bent portion 72.

In addition, the connecting member 70 according to the present exemplary embodiment may further include a protruding portion 74 that protrudes toward the cap plate 20 from one end of the second coupling portion 73 to be combined to the cap plate 20. For example, the protruding portion 74 may be adjacent the first terminal portion 30, and may extend vertically from the cap plate 20 to contact, e.g., directly contact, the second coupling portion 73. As such, a first end of the connecting member 70, i.e., an edge of the second coupling member 73, may be connected to the protruding portion 74, while a second end of the connecting member 70, i.e., an edge of the first coupling member 71, may be connected to the first terminal portion 30.

Accordingly, as illustrated in FIGS. 1-2, the first terminal plate 32 and the cap plate 20 may be electrically coupled to the second electrode 12 of the electrode assembly 10 through the first coupling portion 71, the bent portion 72, the second coupling portion 73, and the protruding portion 74, which are combined, e.g., coupled, to the first terminal plate 32. In other words, the first terminal plate 32 is electrically connected to the second electrode 12 through the first terminal member 31 and the first current collecting member 50a, and is also electrically connected to the cap plate 20 through the connecting member 70.

For example, referring to FIG. 4, the first electrode 11 according to the present exemplary embodiment is positioned at an outer surface of the electrode assembly 10. In this case, the first electrode 11 may be the negative electrode and the second electrode 12 may be the positive electrode. Further, the case 26 may be positively charged, as it is electrically coupled to the second electrode 12 through the connecting member 70. The positively charged case 26 and the first electrode 11, which is the negative electrode, are positioned at opposite sides of the separator 13 while interposing the separator 13 therebetween (enlarged portion in FIG. 4).

Thus, if a conductive material 80 (e.g., a nail) penetrates through the rechargeable battery 100, the conductive material 80 sequentially penetrates through the case 26, the separator 13, the first electrode 11, the separator 13, and the second electrode 12, such that a short-circuit current forms between the first electrode 11 and the second electrode 12. In this case, a short-circuit current path is formed between the first and second electrodes 11 and 12 such that the short-circuit current is discharged outside of the electrode assembly 10 through the conductive material 80, the cap plate 20 combined to the case 26, the connecting member 70, the first terminal plate 32, the first terminal member 31, and the first current collecting member 50a.

Even when the short-circuit current path formed between the first and second electrodes 11 and 12 ceases to exist, the short-circuit current flowing between the first and second electrodes 11 and 12 remains inside of the electrode assembly 10 if a short-circuit state between the first and second electrodes 11 and 12 is maintained by the conductive material 80. As such, ignition or explosion of the electrode assembly 10 due to the residual short-circuit current inside of the electrode assembly 10 may occur, if an amount of the residual short-circuit current inside of the electrode assembly 10 is not minimized.

Therefore, according to the present exemplary embodiment, since the rechargeable battery includes the connecting member 70, the short-circuit current is effectively dissipated through the connecting member 70 that forms part of the short-circuit current path between the first and second electrodes 11 and 12. Accordingly, the amount of the residual short-circuit current inside of the electrode assembly 10 can be minimized.

In detail, according to the present exemplary embodiment, a short-circuit current potentially occurring due to short-circuiting of the first and second electrodes 11 and 12 is discharged from the electrode assembly 10 through a current path including the connecting member 70 that couples the first terminal plate 32 and the cap plate 20, while at least some portion of the connecting member 70 is installed to be spaced apart from the cap plate 20. That is, the short-circuit current passing through the short-circuit current path between the first and second electrodes 11 and 12 is discharged from the electrode assembly 10 and passes through the case 26, the cap plate 20, the protruding portion 74 combined, e.g., coupled, to the cap plate 20, the second coupling portion 73 that is installed to be spaced apart from the cap plate 20, the bent portion 72, the first coupling portion 71, and the fuse portion 51a of the first current collecting member 50a.

In other words, the short-circuit current passing through the short-circuit current path formed between the first and second electrodes 11 and 12 is partially dissipated in the connecting member 70 while passing through the protruding portion 74 of the connecting member 70, the second coupling portion 73, the bent portion 72, and the first coupling portion 71. Accordingly, among the total amount of the short-circuit current passing through the short-circuit current path, the amount of the short-circuit current passing through the fuse portion 51a of the first current collecting member 50a decreases in proportion to the amount of the short-circuit current that is dissipated in the connecting member 70. Thus, according to the present exemplary embodiment, due to the dissipation of the short-circuit current in the connecting member 70, rather than entirely through the fuse portion 51a, a melting time of the fuse portion 51a may be delayed as the amount of the short-circuit current passing through the fuse portion 51a decreases per unit time. In other words, as the short-circuit current partially passes and dissipates through the connecting member 70, the amount of time for passing sufficient current to melt the fuse portion 51a increases.

Further, as the required melting time of the fuse portion 51a increases, as in the present exemplary embodiment, existence of the short-circuit current path between the first and second electrodes 11 and 12 continues for a longer time, e.g., as compared to a rechargeable battery without the connecting member 70 (due to the longer required melting time). Therefore, according to the present exemplary embodiment, since the short-circuit current occurring due to the short-circuit of the first and second electrodes 11 and 12 may be discharged outside of the electrode assembly 10 through the short-circuit current path for a longer time, the amount of the residual short-circuit current after the short-circuit current path ceases to exist may be minimized.

Since the short-circuit current between the first and second electrodes 11 and 12 is proportional to an electrical capacity of the rechargeable battery 100, resistance of the connecting member 70 can be determined in consideration of the electrical capacity of the rechargeable battery 100. For example, the resistance of the connecting member 70 may be controlled by varying respective lengths and/or thicknesses of the first coupling portion 71 of the connecting member 70, the bent portion 72, the second coupling portion 73, and the protruding portion 74 in accordance with the electrical capacity of the rechargeable battery 100, or according to formation materials of the connecting member 70.

In addition, according to the present exemplary embodiment, since the short-circuit current due to the short-circuit of the first and second electrodes 11 and 12, which results from the penetration of the conductive material 80, may be sufficiently discharged to the outside of the electrode assembly 10 through the short-circuit current path during a, e.g., longer, melting delay time of the fuse portion 51a, the electrode assembly 10 may be prevented from catching fire or exploding due to the residual short-circuit current after the short-circuit current path has ceased to exist due to the melting of the fuse portion 51a.

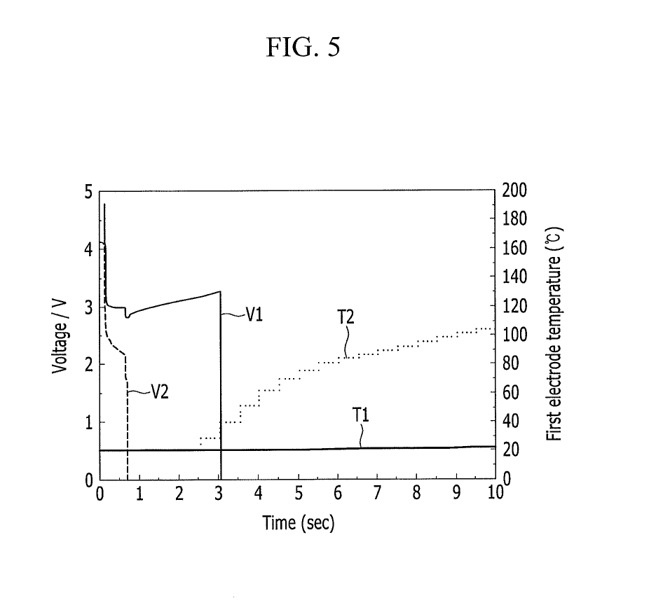

FIG. 5 is a graph for comparing voltage and temperature variations of first electrodes of the rechargeable battery through which a conductive foreign material penetrates and a conventional rechargeable battery through which a conductive foreign material penetrates.

Referring to FIG. 5, when conductive material penetrates through a conventional rechargeable battery to short-circuit the negative and positive electrodes, voltage V2 of the conventional electrode assembly becomes 0 V about 0.8 seconds after the short-circuit occurs. Further, the temperature T2 of the negative electrode of the conventional electrode assembly increases from about 20° C. to about 102° C. about 10 s after the short-circuit occurs.

In contrast, when the conductive material 80 penetrates through the rechargeable battery 100 according to the present exemplary embodiment and short-circuits the negative and positive electrodes, voltage V1 of the electrode assembly 10 becomes 0 V about 3 seconds after the short-circuit occurs. Further, temperature T1 of the negative electrode of the electrode assembly 10 does not change, i.e., is maintained at about 20° C., despite the short circuit, e.g., even about 10 seconds after the short-circuit occurs.

In this case, voltage V2 in the conventional rechargeable battery, i.e., the voltage between the negative and positive electrodes, drops to about 0 V within about 0.8 seconds after a short-circuit between negative and positive electrodes because the fuse of the conventional rechargeable battery operates in 0.8 seconds after the negative and positive electrodes are short-circuited. Thus, the short-circuit current path via the fuse in the conventional rechargeable battery ceases to exist within 0.8 seconds. Further, in the conventional rechargeable battery, the temperature T2 of the negative electrode of the electrode assembly increases to 102° C., which is higher than the initial temperature by 82° C., because the negative electrode of the conventional electrode assembly is heated by undischarged residual short-circuit current in the electrode assembly, i.e., undischarged residual current due to a premature termination of the short-circuit current path in 0.8 seconds.

In contrast, in accordance with the present exemplary embodiment, the voltage V1 of the electrode assembly 10 drops to 0 V about 3 seconds after the first and second electrodes 11 and 12 are short-circuited by the conductive material 80, since the fuse portion 51a melts about 3 seconds after the first and second electrodes 11 and 12 are short-circuited. Thus, the short-circuit current path formed between the first and second electrodes 11 and 12 through the fuse portion 51a ceases to exist within about 3 seconds, i.e., the short-circuit current path formed in the rechargeable battery 100 exists for a duration that is more than three times longer than the duration of the short-circuit current path in the conventional rechargeable battery.

The melting time of the fuse portion 51a according to the present exemplary embodiment is delayed by about 2.2 seconds, as compared with the operation time of the fuse of the conventional rechargeable battery, because the short-circuit current is dissipated in the connecting member 70 according to the present exemplary embodiment. Thus, the amount of the short-circuit current passing through the fuse portion 51a per unit time decreases.

Further, the temperature T1 of the first electrode 11, which is the negative electrode of the electrode assembly 10 according to the present exemplary embodiment, does not increase from the initial temperature even about 10 seconds after the short-circuit occurs because the melting time of the fuse portion 51a is delayed, i.e., the longer time enables more discharge of current and heat. Thus, the short-circuit current path existence for a longer time increases the amount of short-circuit current discharged outside of the electrode assembly 10 through the current path to be mostly dissipated in the connecting member 70.

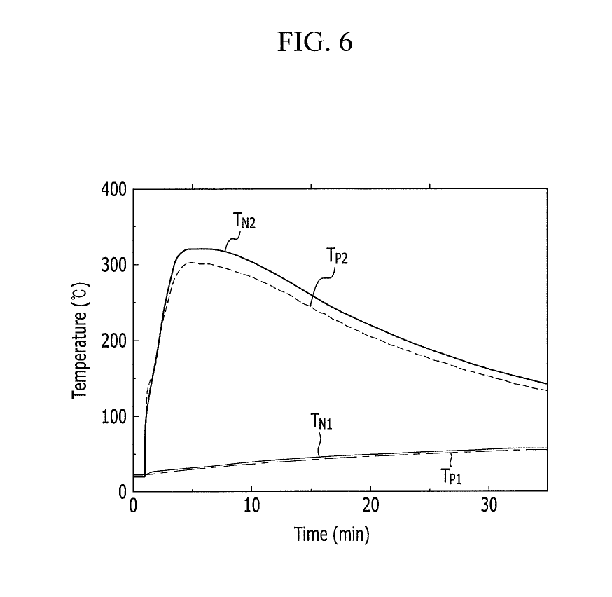

FIG. 6 is a graph illustrating temperature variation of negative and positive electrodes according to time after a fuse operates in the conventional rechargeable battery, and temperature variation of negative and positive electrodes according to time after a fuse portion of the rechargeable battery 100 of FIG. 1 is melted.

Referring to FIG. 6, in the conventional rechargeable battery, temperature T_{N2} of the negative electrode of the electrode assembly increases from about 20° C. to about 320° C. about 5 minutes after a fuse melts, and then gradually decreases. Similarly, the temperature Tₚ₂ of the positive electrode of the electrode assembly increases from about 20° C. to about 300° C., and then gradually decreases. In this case, in the conventional rechargeable battery, the temperatures T_{N2} and T_{P2} of the negative and positive electrodes abruptly increase about 5 minutes after the fuse melts because the negative and positive electrodes are abruptly, e.g., rapidly, heated by the short-circuit current that is not discharged from the electrode assembly.

In contrast, in the rechargeable battery 100 according to the present exemplary embodiment, the temperature T_{N1} of the first electrode 11 and the temperature T_{P1} of the second electrode 12 increase by about 5° C. from the initial temperature of about 20° C. about 5 min after the fuse portion 51a melts, and further increase to about 30° C. about 35 min after the short-circuit current ceases to exist due to the melting of the fuse portion 51a. In this case, according to the present exemplary embodiment, the temperature T_{N1} of the first electrode 11 and the temperature T_{P1} of the second electrode 12 do not increase much because the melting time of the fuse portion 51a is delayed by the connecting member 70 and the duration of the short-circuit current path is further increased to cause the short-circuit current discharged outside of the electrode assembly 10 through the current path to be mostly dissipated in the connecting member 70, such that there is no residual short-circuit current at all or only a minimal amount of the residual short-circuit current.

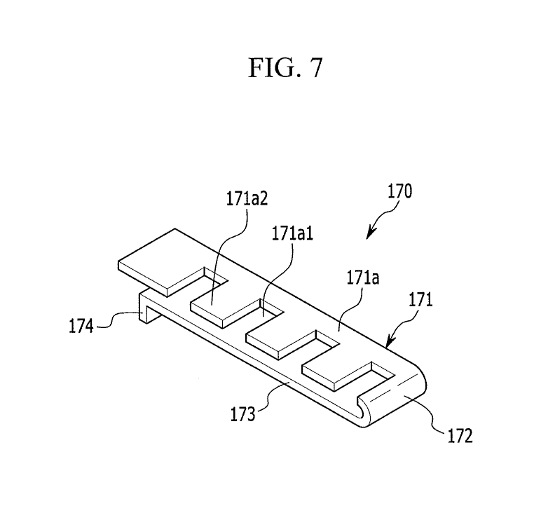

FIG. 7 is a perspective view of a connecting member according to a second exemplary embodiment of the present disclosure.

Referring to FIG. 7, a connecting member 170 according to the present exemplary embodiment is formed of a conductive material, e.g., including aluminum or an alloy including aluminum, and includes a first coupling portion 171, a bent portion 172, a second coupling portion 173, and a protruding portion 174. In this case, the connecting member 170 according to the present exemplary embodiment has the same configuration as the connecting member 70 according to the first exemplary embodiment except for the first coupling portion 171. Hereinafter, a detailed description of the same configuration as that of the connecting member 70 according to the first exemplary embodiment will be omitted.

The first coupling portion 171 of the connecting member 170 according to the present exemplary embodiment may include a first coupling portion body 171a that is formed with a plurality of protrusions 171a2. In detail, the first coupling portion body 171a may include a plurality of grooves 171a1 that are formed toward inside of the first coupling portion body 171a from a circumference of the first coupling portion body 171a while being respectively spaced apart by a predetermined interval, and a plurality of protrusions 171a2 that protrude between the adjacent grooves 171a1 toward the circumference of the first coupling portion body 171a from inside of the first coupling portion body 171a.

Accordingly, in the present exemplary embodiment, when the short-circuit current discharged through the short-circuit current path inside the electrode assembly 10 passes through the connecting member 170, it passes through all of the plurality of protrusions 171a2 that are formed in the first coupling portion body 171a. Therefore, dissipation efficiency of the short-circuit current to the connecting member 170 may be improved.

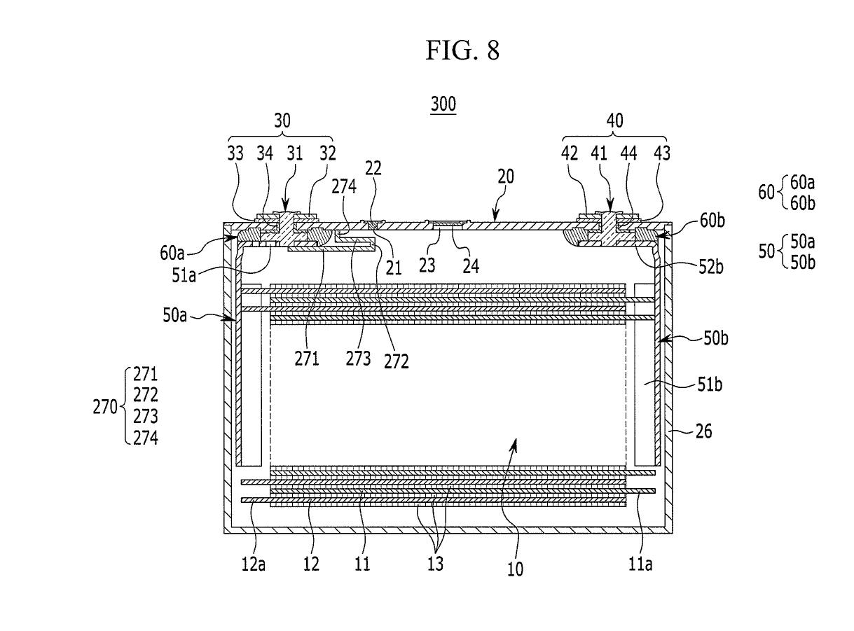

FIG. 8 is a cross-sectional view of a rechargeable battery according to a third exemplary embodiment of the present disclosure.

Referring to FIG. 8, a rechargeable battery 300 according to the present exemplary embodiment has the same configuration as the rechargeable battery 100 according to the first exemplary embodiment of the present disclosure except for a connecting member 270. Hereinafter, a detailed description of the same configuration as that of the rechargeable battery 100 according to the first exemplary embodiment of the present disclosure will be omitted.

The connecting member 270 according to the present exemplary embodiment is formed of a conductive material, e.g., including aluminum or an alloy including aluminum, and includes a first coupling portion 271, a bent portion 272, and a second coupling portion 273. In this case, the connecting member 270 according to the present exemplary embodiment is installed inside of the case 26 so as to face the electrode assembly 10.

In detail, one end of the first coupling portion 271 is coupled to an inner end of the first terminal member 31 inside of the case 26, and is elongated in a direction away from the terminal member 31 in parallel with one side of the cap plate 20 that faces the electrode assembly 10. The bent portion 272 is bent to be elongated toward the one side of the cap plate 20 facing the electrode assembly 10 at the other end of the first coupling portion 271. The second coupling portion 273 is at least partially spaced apart from the cap plate 20, and is elongated from the bent portion 272 substantially in parallel with the first coupling portion 271 and in a direction toward the first terminal member 31 so as to be coupled to the cap plate 20. In addition, the connecting member 270 according to the present exemplary embodiment may further include a protruding portion 274, which protrudes toward the one side of the cap plate 20 facing the electrode assembly 10 from one end of the second coupling portion 273 so as to be coupled to the one side of the cap plate 20.

The first terminal member 31 and the cap plate 20 may be electrically coupled to the second electrode 12 of the electrode assembly 10 through the first coupling portion 271, the bent portion 272, the second coupling portion 273, and the protruding portion 274, which are coupled to the first terminal member 31. Accordingly, a volume increase of the rechargeable battery 300 may be prevented, as the connecting member 270 is installed inside, i.e., rather than outside, of the case 26 that is sealed by the cap plate 20.

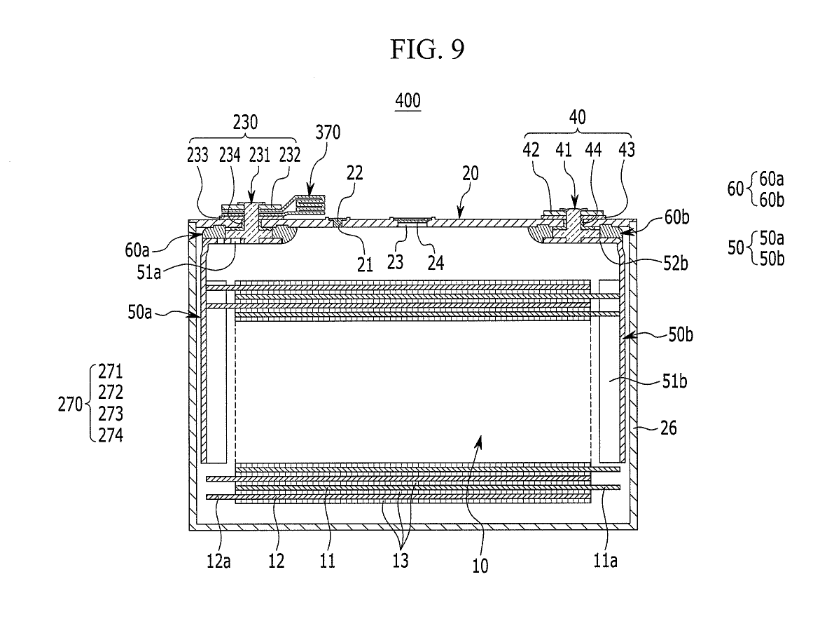

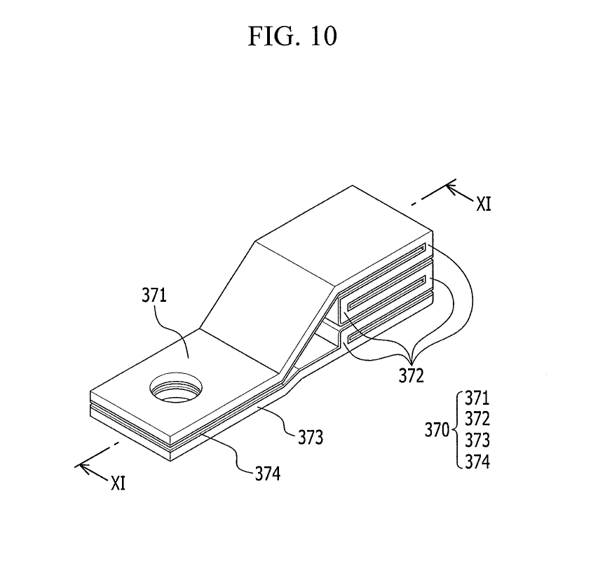

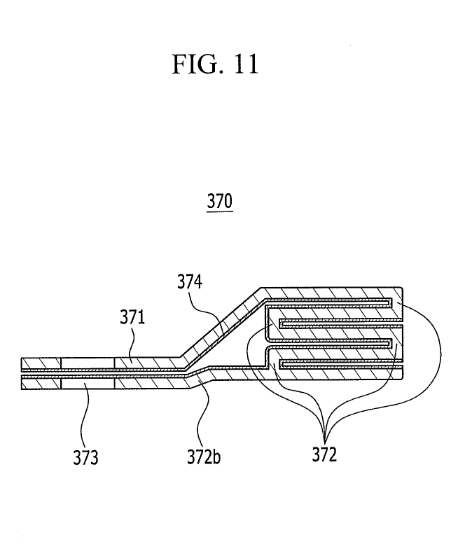

FIG. 9 is a cross-sectional view of a rechargeable battery according to a fourth exemplary embodiment of the present disclosure, FIG. 10 is a perspective view of a connecting member of the rechargeable battery of FIG. 9, and FIG. 11 is a cross-sectional view of FIG. 10 taken along the line XI-XI.

Referring to FIGS. 9 to 11, a rechargeable battery 400 according to the present exemplary embodiment has the same configuration as the rechargeable battery 100 according to the first exemplary embodiment of the present disclosure except for a first terminal portion 230 and a connecting member 370. Hereinafter, a detailed description of the same configuration as that of the rechargeable battery 100 according to the first exemplary embodiment of the present disclosure will be omitted.

The first terminal portion 230 according to the present exemplary embodiment may include a first terminal member 231, a first terminal plate 232, a first terminal insulating member 233, and a first gasket 234. In this case, the first terminal member 231 may be installed to penetrate through the cap plate 20 while being electrically coupled to the second electrode 12 of the electrode assembly 10 through the first current collecting member 50a. The first terminal plate 232 may be combined, e.g., coupled, to the first terminal member 231 such that it is electrically coupled to the second electrode 12 of the electrode assembly 10 through the first terminal member 231. The first gasket 234 may be installed between the first terminal member 231 and the cap plate 20 to insulate therebetween.

The connecting member 370 according to the present exemplary embodiment includes a first coupling portion 371, a bent portion 372, a second coupling portion 373, and insulating layers 374. In detail, the first coupling portion 371 is positioned between the cap plate 20 and the first terminal plate 232 such that it is coupled to the first terminal plate 232. The bent portion 372 is bent to be elongated toward the cap plate 20 at one end of the first coupling portion 371. In this case, the bent portion 372 according to the present exemplary embodiment may include a plurality of bent portions, and cross-sections of the plurality of bent portions 372 may have a sinuous filament shape.

The second coupling portion 373 is at least partially spaced apart from the cap plate 20 and is elongated from the bent portion 372 in a direction approaching the first terminal member 231 substantially in parallel with the first coupling portion 371, such that it is positioned between the cap plate 20 and the first terminal plate 232 so as to be coupled to the cap plate 20. In this case, the first gasket 233 is installed between the second coupling portion 373 and the first terminal member 231 to prevent the second coupling portion 373 and the first terminal member 231 from directly contacting each other.

The insulating layers 374 are respectively formed on surfaces of the first coupling portion 371 and the second coupling portion 373 facing each other to prevent the first coupling portion 371 and the second coupling portion 373 from being electrically coupled to each other. The insulating layers 374 according to the present exemplary embodiment are formed between the plurality of bent portions 372 to prevent a current from flowing therebetween. In this case, the insulating layers 374 are formed by forming oxide layers on surfaces of the first coupling portion 371, the bent portions 372, and the second coupling portion 373 by a deposition or anodizing method, or by coating the surfaces of the first coupling portion 371, the bent portions 372, and the second coupling portion 373 with a polymer.

According to the present exemplary embodiment, after the conductive material 80 penetrates through the rechargeable battery 400, the short-circuit current due to the short-circuit of the first and second electrodes 11 and 12 is introduced into the second electrode 12 through the short-circuit current path in the electrode assembly 10 by way of the second coupling portion 373 of the connecting member 370, the plurality of bent portions 372, the first coupling portion 371, and first terminal member 231. In this case, since the short-circuit current discharged from the electrode assembly 10 passes through the sinuous bent portions 372, dissipation efficiency of the short-circuit current may be improved in the connecting member 370.

Further, according to the present exemplary embodiment, when the short-circuit current passes through the sinuous bent portions 372, heat generated at the sinuously formed bent portions 372 can be efficiently discharged to prevent the case 26 from being internally overheated. In addition, the connecting member 370 according to the present exemplary embodiment may be installed inside of the case 26 in which the electrode assembly 10 is placed, as well as outside of the case 26.

By way of summation and review, when a conductive object, e.g., a conductive nail and the like, penetrates through a case of a rechargeable battery and enters therein, a negative electrode and a positive electrode of an electrode assembly may be short-circuited. In this case, when a terminal and the case, which are electrically coupled to the electrode assembly, are electrically coupled, a short-circuit current path is formed between the negative and positive electrodes due to penetration of the conductive object, i.e., material. However, if a fuse of the rechargeable battery melts and discontinues the short-circuit current path before the short-circuit current of the short-circuit current path between the negative and positive electrodes is sufficiently discharged, the temperature of the electrode assembly increases, i.e., due to the residual short-circuit current remaining therein, thereby increasing a risk for ignition or explosion of the electrode assembly.

In contrast, example embodiments provide a rechargeable battery including a structure that can prevent ignition and explosion of an electrode assembly by preventing temperature of the electrode assembly from increasing due to a short-circuit current. That is, according to example embodiments, the short-circuit current discharged from the electrode assembly of the rechargeable battery can be dissipated outside of the electrode assembly to prevent the temperature of the electrode assembly from increasing, thereby preventing the electrode assembly from catching fire or exploding due to the temperature increase of the electrode assembly.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly in a case;
a cap plate sealing an opening of the case;
a terminal portion electrically coupled to the electrode assembly, the terminal portion being on the cap plate; and
a connecting member extending from the terminal portion and being spaced apart from the cap plate, the connecting member electrically coupling the terminal portion and the cap plate.

2. The rechargeable battery as claimed in claim 1, wherein the connecting member includes a first coupling portion coupled to the terminal portion, a bent portion bent toward the cap plate from the first coupling portion, and a second coupling portion elongated from the bent portion and coupled to the cap plate.

3. The rechargeable battery as claimed in claim 2, wherein the connecting member further includes a protruding portion coupled to the cap plate, the protruding portion extending toward the cap plate from an end of the second coupling portion.

4. The rechargeable battery as claimed in claim 3, wherein the second coupling portion is spaced apart from the cap plate.

5. The rechargeable battery as claimed in claim 3, wherein the first coupling portion includes a first coupling portion body with a plurality of protrusions.

6. The rechargeable battery as claimed in claim 2, wherein the terminal portion includes:
a terminal member penetrating through the cap plate and electrically coupled to the electrode assembly, and
a terminal plate coupled to the terminal member, the terminal plate being electrically coupled to the cap plate via the connecting member.

7. The rechargeable battery as claimed in claim 6, wherein the first coupling portion is positioned between the cap plate and the terminal plate to be coupled to the terminal plate, the second coupling portion is positioned between the cap plate and the terminal plate to be coupled to the cap plate, and insulating layers are positioned on surfaces of the first coupling portion and the second coupling portion facing each other.

8. The rechargeable battery as claimed in claim 7, wherein the bent portion includes a plurality of bent portions.

9. The rechargeable battery as claimed in claim 8, wherein a cross-section of each of the bent portions has a sinuous filament shape.

10. The rechargeable battery as claimed in claim 1, wherein the connecting member is inside of the case and faces the electrode assembly.

11. The rechargeable battery as claimed in claim 1, wherein the connecting member has a rotated U-shape, a first end of the U-shape being connected to the terminal portion, and a second end of the U-shape being connected to the cap plate.

12. The rechargeable battery as claimed in claim 11, wherein the rotated U-shape extends continuously from the terminal portion along the cap plate to completely overlap an injection opening in the cap plate.

13. The rechargeable battery as claimed in claim 11, wherein only the second end of the rotated U-shape contacts the cap plate.
